(19) United States
(12) Patent Application Publication
(10) Pub. No.: US 2019/0138162 A1
(43) Pub. Date: May 9, 2019

(54) SYSTEMS AND METHODS FOR PROVIDING CALLS-TO-ACTION AND RELATED CONTENT ASSOCIATED WITH VIRTUAL MEDIA CONTENT

(71) Applicant: Facebook, Inc., Menlo Park, CA (US)

(72) Inventors: Maria Zverina, London (GB); Dariia Stroganova, London (GB)

(21) Appl. No.: 15/805,555

(22) Filed: Nov. 7, 2017

(51) Int. Cl. G06F 3/0482; G06N 99/00

(52) U.S. Cl. CPC G06F 3/0482; G06Q 30/0623; G06N 99/005

(57) ABSTRACT

Systems, methods, and non-transitory computer readable media can provide virtual media content including one or more items in a user interface. A call-to-action (CTA) associated with at least one item of the one or more items can be provided within the virtual media content. Information associated with the at least one item can be provided within the virtual media content in response to selection of the CTA.

### FIELD OF THE INVENTION

The present technology relates to the field of social networks. More particularly, the present technology relates to techniques for providing content within virtual media content.

### BACKGROUND

Today, people often utilize computing devices (or systems) for a wide variety of purposes. Users can operate their computing devices to, for example, interact with one another, create content, share content, and access information. Under conventional approaches, content items (e.g., images, videos, audio files, etc.) can be made available through a content sharing platform. Users can operate their computing devices to access the content items through the platform. Typically, the content items can be provided, or uploaded, by various entities including, for example, content publishers and also users of the content sharing platform. The content items can be accessed in various environments, such as two dimensional or three dimensional environments.

### SUMMARY

Various embodiments of the present disclosure can include systems, methods, and non-transitory computer readable media configured to provide virtual media content including one or more items in a user interface. A call-to-action (CTA) associated with at least one item of the one or more items can be provided within the virtual media content. Information associated with the at least one item can be provided within the virtual media content in response to selection of the CTA.

In some embodiments, the virtual media content includes one or more of: a 360 photo or a 360 video.

In certain embodiments, the virtual media content is a virtual media advertisement.

In an embodiment, the one or more items are defined based on user input.

In some embodiments, the one or more items include one or more of an object or a face detected in the virtual media content.

In certain embodiments, the object or the face is detected based on a machine learning model.

In an embodiment, the CTA associated with the at least one item is determined based on a machine learning model.

In some embodiments, the information associated with the at least one item includes one or more of: a detailed view of the at least one item, media content associated with the at least one item, or a CTA associated with initiating a transaction associated with the at least one item.

In certain embodiments, the information associated with the at least one item is provided in a separate screen within the virtual media content.

In an embodiment, the CTA and the information associated with the at least one item are provided as an overlay in the virtual media content.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example virtual media ad module configured to provide virtual media ads, according to an embodiment of the present disclosure.

FIG. 2A illustrates an example item identification module configured to identify items for which to provide CTAs, according to an embodiment of the present disclosure.

FIG. 2B illustrates an example ad CTA module configured to provide CTAs and related content for items within virtual media ads, according to an embodiment of the present disclosure.

FIG. 3A illustrates an example user interface for providing virtual media ads, according to an embodiment of the present disclosure.

FIG. 3B illustrates an example user interface for providing virtual media ads, according to an embodiment of the present disclosure.

FIG. 4 illustrates an example first method for providing virtual media ads, according to an embodiment of the present disclosure.

FIG. 5 illustrates an example second method for providing virtual media ads, according to an embodiment of the present disclosure.

FIG. 6 illustrates a network diagram of an example system that can be utilized in various scenarios, according to an embodiment of the present disclosure.

FIG. 7 illustrates an example of a computer system that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Providing Calls-To-Action And Related Content Associated With Virtual Media Content

People use computing devices (or systems) for a wide variety of purposes. As mentioned, under conventional approaches, a user can utilize a computing device to share content items (e.g., documents, images, videos, audio, etc.) with other users. Under conventional approaches, content items (e.g., images, videos, audio files, etc.) can be made available through a content sharing platform. Users can operate their computing devices to access the content items through the platform. Typically, the content items can be provided, or uploaded, by various entities including, for example, content publishers and also users of the content sharing platform. An example of the content sharing platform can include a social networking system.

In some instances, a user can access virtual content or virtual media content, for example, through a display screen of their computing device, a virtual reality system, or a head mounted display, to name a few examples. The virtual media content may be composed using one or more images and/or videos that capture or present various scenes. Such scenes may be from the real world and/or be computer generated. In some instances, the virtual media content is composed so that the user is able to navigate within the scenes presented by the virtual media content. Thus, by accessing the virtual media content, the user is able to experience and navigate the presented scenes virtually, for example, as if the user were physically present in the scenes. Examples of virtual media content can include 360 photos, spherical or 360 videos, augmented reality (AR) content, virtual reality (VR) content, etc. Conventional approaches specifically arising in the realm of computer technology may provide advertisements (“ads”) in the form of virtual media content. For example, an ad can be provided in the form of a 360 photo. However, conventional approaches may not provide interactive ad content within virtual media content.

An improved approach rooted in computer technology can overcome the foregoing and other disadvantages associated with conventional approaches specifically arising in the realm of computer technology. Based on computer technology, the disclosed technology can provide calls-to-action (CTAs) and related content within virtual media advertisements, such as 360 photos or 360 videos. For example, an ad can be provided in the form of virtual media content. Virtual media content, such as a 360 photo and a 360 video, can provide an immersive experience and depict various types of content and scenes. The disclosed technology can provide one or more CTAs associated with items depicted in a virtual media ad. Examples of items can include objects, faces, locations, or any other content depicted in a virtual media ad. In some embodiments, an entity associated with a virtual media ad can define an item within a virtual media ad for which to provide a CTA. In other embodiments, items within a virtual media ad can be identified based on object detection or recognition techniques, face detection or recognition techniques, etc. As a user navigates through a virtual media ad, a CTA associated with an item that the user is viewing can be provided to the user within the virtual media ad. Content relating to the item can be provided in response to user selection of the CTA. For example, detailed information about the item or media content relating to the item can be provided in a separate window. In this manner, interactive ad content can be provided within virtual media ads and provide an engaging user experience in connection with items that are presented within virtual media ads. The disclosed technology can apply to any virtual media content. Additional details relating to the disclosed technology are provided below.

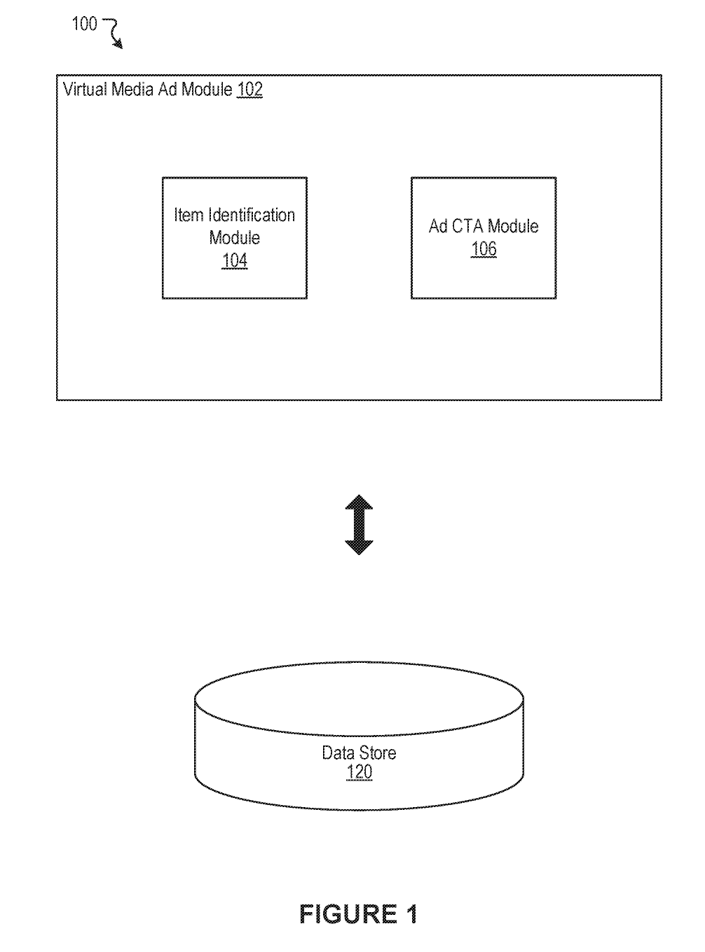

FIG. 1 illustrates an example system 100 including an example virtual media ad module 102 configured to provide virtual media ads, according to an embodiment of the present disclosure. The virtual media ad module 102 can include an item identification module 104 and an ad CTA module 106. In some instances, the example system 100 can include at least one data store 120. The components (e.g., modules, elements, steps, blocks, etc.) shown in this figure and all figures herein are exemplary only, and other implementations may include additional, fewer, integrated, or different components. Some components may not be shown so as not to obscure relevant details. In various embodiments, one or more of the functionalities described in connection with the virtual media ad module 102 can be implemented in any suitable combinations. While the disclosed technology is described in connection with virtual media content and CTAs associated with a social networking system for illustrative purposes, the disclosed technology can apply to any other type of system and/or content.

Content in accordance with the present technology can be any type of content. Types of content can include an image (e.g., two dimensional (2D) image), a video (e.g., 2D videos), virtual content or virtual media content (e.g., panoramic photos, 360 photos, photo spheres, 360 videos, virtual reality (VR) environments), audio, or a combination thereof. The virtual media content can be any content that provides an immersive experience. For example, the virtual media content can capture a field of view of various degrees (e.g., 180 degrees, 225 degrees, 360 degrees, etc.) and/or present any three-dimensional (3D) content or environments. The virtual media content can present an environment of any shape, such as a sphere, a cube, a pyramid, etc. In one example, the virtual media content can include a spherical video (or 360 video) that captures a 360 degree view of a scene. Some examples can include videos composed using monoscopic 360 degree views, videos composed using stereoscopic 180 degree views, etc. The spherical video can be created by stitching together various video streams, or feeds, that were captured by cameras that are placed at different locations and/or positions to capture a 360 degree view of the scene. Such video streams may be predetermined for various angles (e.g., 0 degree, 30 degrees, 60 degrees, etc.) of the spherical video. Once stitched together, a user can access the spherical video through a viewport to view a portion of the spherical video at some angle. The portion of the spherical video shown to the user can be determined based on the location and direction of the viewport in three-dimensional space. In another example, virtual media content can include virtual reality (VR) content and environments. VR constitutes simulated environments presented through a viewport mounted within headgear or other equipment worn by a user. The simulated environments can be replications of actual places or fictional worlds that are presented via the equipment. A user has the ability to move freely in the simulated environment and to interact with it as desired. A user can interact with the simulated environment through commands provided to the equipment or user gestures detected by the equipment. In some embodiments, a virtual media ad can indicate an ad that is in the form of virtual media content, such as a 360 photo or 360 video.

The item identification module 104 can identify items in virtual media content for which to provide CTAs. For example, items within virtual media content can be defined based on user input. As another example, items, such as objects or faces, within virtual media content can be detected based on machine learning techniques. Functionality of the item identification module 104 is described in more detail herein.

The ad CTA module 106 can provide CTAs and related content for items within virtual media content, such as virtual media ads. CTAs for one or more identified items can be provided within virtual media ads. Related content for an item can be provided in response to selection of a corresponding CTA by a user. Functionality of the ad CTA module 106 is described in more detail herein.

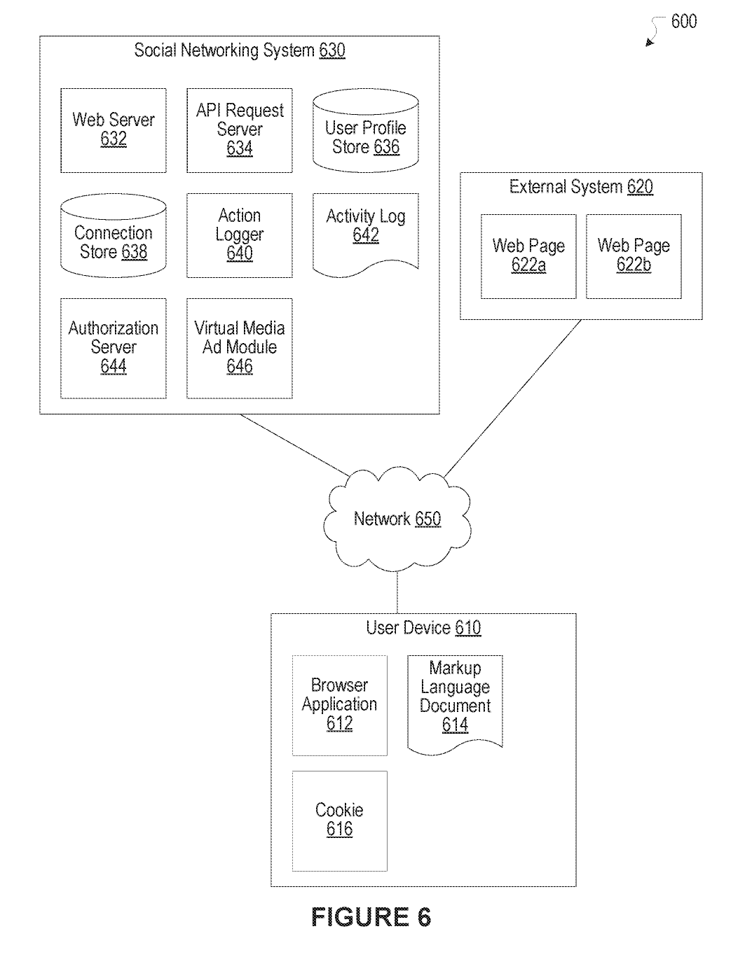

In some embodiments, the virtual media ad module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the virtual media ad module 102 can be, in part or in whole, implemented as software running on one or more computing devices or systems, such as on a server system or a client computing device. In some instances, the virtual media ad module 102 can be, in part or in whole, implemented within or configured to operate in conjunction or be integrated with a social networking system (or service), such as a social networking system 630 of FIG. 6. Likewise, in some instances, the virtual media ad module 102 can be, in part or in whole, implemented within or configured to operate in conjunction or be integrated with a client computing device, such as the user device 610 of FIG. 6. For example, the virtual media ad module 102 can be implemented as or within a dedicated application (e.g., app), a program, or an applet running on a user computing device or client computing system. It should be understood that many variations are possible.

The data store 120 can be configured to store and maintain various types of data, such as the data relating to support of and operation of the virtual media ad module 102. The data maintained by the data store 120 can include, for example, information relating to virtual media content, virtual media ads, CTAs, related content, object detection or recognition, face detection or recognition, etc. The data store 120 also can maintain other information associated with a social networking system. The information associated with the social networking system can include data about users, social connections, social interactions, locations, geo-fenced areas, maps, places, events, groups, posts, communications, content, account settings, privacy settings, and a social graph. The social graph can reflect all entities of the social networking system and their interactions. As shown in the example system 100, the virtual media ad module 102 can be configured to communicate and/or operate with the data store 120. In some embodiments, the data store 120 can be a data store within a client computing device. In some embodiments, the data store 120 can be a data store of a server system in communication with the client computing device.

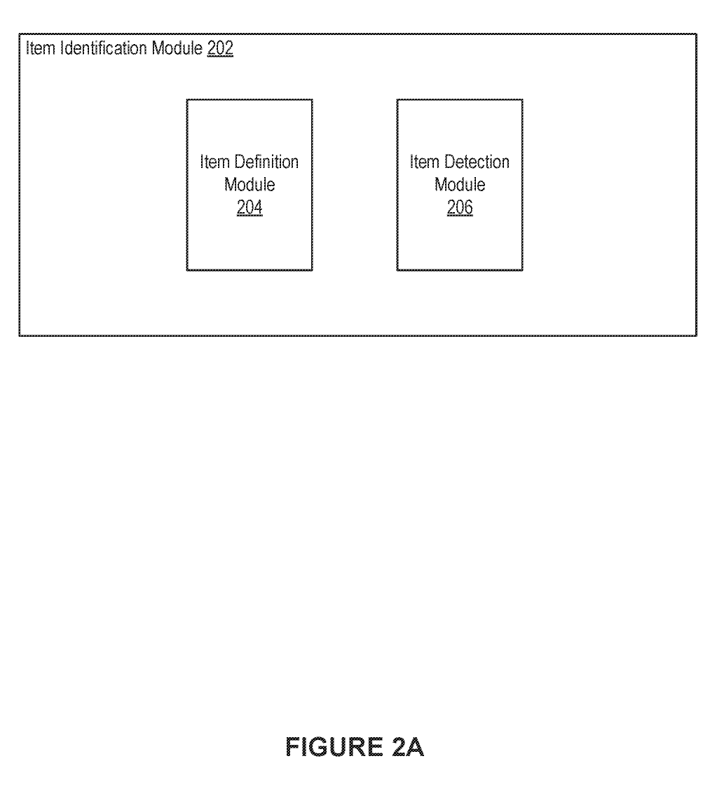

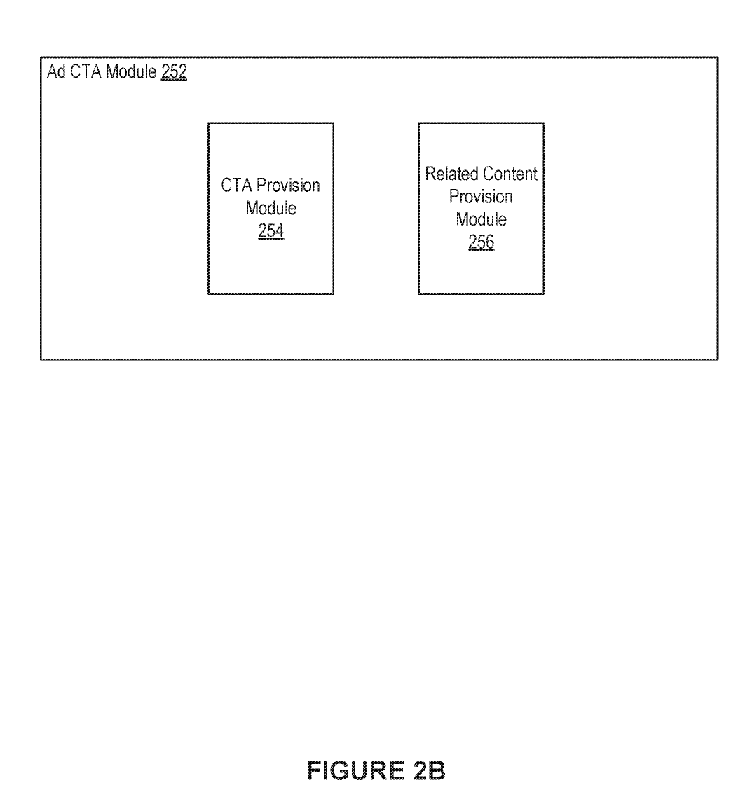

FIG. 2A illustrates an example item identification module 202 configured to identify items for which to provide CTAs, according to an embodiment of the present disclosure. In some embodiments, the item identification module 104 of FIG. 1 can be implemented with the example item identification module 202. As shown in the example of FIG. 2A, the example item identification module 202 can include an item definition module 204 and an item detection module 206.

The item identification module 202 can identify items within virtual media content based on various techniques, such as definition of an item by a user, detection of an item, such as an object or a face, etc. For example, virtual media content can include a 360 photo or a 360 video. Various techniques for identifying items can be used separately or in combination. CTAs can be provided for items identified within virtual media content. A CTA can indicate a particular action that can be taken in connection with an item. The action can be performed by a user experiencing the virtual media content. Examples of CTAs can include shop now, learn more, add to cart, view details, etc. Many variations are possible.

The item definition module 204 can define items within virtual media content based on user input. The item definition module 204 can allow users, such as admins for entities associated with virtual media content, to define items within virtual media content for which to provide CTAs. As an example, particular virtual media content can include a specific object in a scene captured from the real world, and a user can designate the specific object as an item for which to provide a CTA. As another example, a user can designate a portion or region within particular virtual media content, which may not correspond to an object, as an item for which to provide a CTA. For instance, particular virtual media content can depict a store, and a user can designate a specific section of the store as an item for which to provide a CTA. As an additional example, a user can designate a face or a person as an item for which to provide a CTA. In one implementation, a celebrity can be a model for a store, and the celebrity can be designated as an item for which to provide a CTA. Many variations are possible.

The item detection module 206 can detect items within virtual media content. For example, the item detection module 206 can detect items, such as objects and faces, within particular virtual media content. The item detection module 206 can detect items based on machine learning techniques. For example, the item detection module 206 can detect or recognize objects or faces based on object detection or recognition techniques, facial detection or recognition techniques, etc. In some embodiments, the item detection module 206 can train a machine learning model based on training data that includes images of objects or faces and corresponding labels. Virtual media content can be applied to the trained machine learning model in order to determine objects or faces included within virtual media content. In some embodiments, objects or faces can move from one scene to another within particular virtual media content, such as a 360 video, and objects or faces can be tracked between scenes in order to detect the objects or faces. In some embodiments, duplicates of the same object can be detected. For example, a store can display multiples of the same shirt. In these embodiments, the item detection module 206 can provide or count only one instance of a detected object in order to prevent providing multiple CTAs for the same object.

One or more machine learning models discussed in connection with the virtual media ad module 102 and its components can be implemented separately or in combination, for example, as a single machine learning model, as multiple machine learning models, as one or more staged machine learning models, as one or more combined machine learning models, etc. All examples herein are provided for illustrative purposes, and there can be many variations and other possibilities.

FIG. 2B illustrates an example ad CTA module 252 configured to provide CTAs and related content for items within virtual media ads, according to an embodiment of the present disclosure. In some embodiments, the ad CTA module 106 of FIG. 1 can be implemented with the example ad CTA module 252. As shown in the example of FIG. 2B, the example ad CTA module 252 can include a CTA provision module 254 and a related content provision module 256.

The CTA provision module 254 can provide CTAs for one or more identified items within virtual media content. Provision of a CTA for an identified item within particular virtual media content experienced by a user can include presentation of the CTA within a threshold distance from appearance of the identified item within the virtual media content. Items within virtual media content can be identified by the item identification module 202, as described above. In some embodiments, the CTA provision module 254 can provide one or more CTAs based on a viewport of a user. A viewport can indicate what a user is viewing within particular virtual media content. A user can navigate within particular virtual media content based on the viewport. For example, a user can access or view a portion of a 360 photo or a 360 video that is shown in the viewport at a given time. The CTA provision module 254 can provide one or more CTAs for items that are shown in the viewport. In some embodiments, the CTA provision module 254 can provide CTAs for all items in the viewport. In other embodiments, the CTA provision module 254 can provide CTAs for some items in the viewport, for example, to prevent providing too many CTAs to a user. In these embodiments, the CTA provision module 254 can dynamically determine for which items in the viewport to provide CTAs. In some embodiments, CTAs to provide for items in particular virtual media content can be determined at a time the virtual media content is created or uploaded to a social networking system. In other embodiments, CTAs to provide for items in particular virtual media content can be determined at a time when or before the virtual media content is presented to or accessed by a user.

In some embodiments, the CTA provision module 254 can select a CTA for an item based on machine learning techniques. The CTA provision module 254 can train a machine learning model to select one or more CTAs to provide to users in connection with items. In some embodiments, the machine learning model can be trained to select a CTA to provide for a particular item. For example, the machine learning model can be trained based on training data including items, CTAs associated with the items, and labels indicating whether users selected or otherwise interacted with the CTAs. The training data can include various features. For example, features can relate to user attributes, item attributes, etc. User attributes can include any attributes associated with users. Examples of user attributes can include a location (e.g., a country, state, county, city, etc.), an age, an age range, a gender, a language, interests (e.g., topics in which the user has expressed interest), a number of connections (e.g., friends or followers), a computing device, an operating system (OS), etc. Item attributes can include any attributes associated with items. Examples of item attributes can include an object or a face associated with an item, a subject matter, a popularity associated with an item (e.g., an extent to which users interact with an item), etc. In certain embodiments, the machine learning model can be trained to select items for which to provide CTAs and CTAs to provide for the selected items. For example, a CTA may not be provided for all items within particular virtual media content or all items shown in a viewport at a particular time, and the machine learning model can predict for which items to provide CTAs based on a likelihood of users selecting or interacting with the CTAs. The machine learning model can also predict which CTAs to provide for items that have been selected by the machine learning model. In certain embodiments, the CTA provision module 254 can customize CTAs for a particular user.

The related content provision module 256 can provide related content for an item in response to selection of a CTA by a user. For example, a user may select a CTA by a click, a touch gesture, etc. Related content for an item can include any content that is associated with the item for which a CTA is provided and selected. As an example, related content for an item can be detailed information relating to the item. Detailed information can include a detailed view of an item, such as an image. As another example, related content for an item can be media content, such as an image or a video, that is dedicated to the item. As a further example, related content of an item can be a list of products or a catalog associated with the item. Many variations are possible. As an additional example, related content of an item can include one or more CTAs. The related content provision module 256 can provide related content for an item in various ways. In some embodiments, related content for an item can be provided in a separate window or screen. A separate window or screen can be presented in a portion of the viewport or the entire viewport. The CTA that triggers provision of related content may be included in the separate window or screen. Or a different CTA can be provided in the separate window or screen. In other embodiments, related content for an item can be provided within virtual media content without a separate window or screen. Related content can allow a user to initiate and complete a transaction or a workflow associated with an item. For example, a user can purchase a product through related content presented in connection with an item.

The ad CTA module 252 can provide CTAs and related content in connection with various scenarios. As an example, particular virtual media content can depict the interior of a store, and items identified within the virtual media content can include various products on display in the store. A CTA can be provided for some or all of products on display. For instance, a CTA can be provided for each unique product, and information relating to the product can be provided in response to selection of the CTA. As another example, particular virtual media content can depict the interior of a store, and items identified within the virtual media content can include different sections of the store. A CTA can be provided to shop for products available in a particular section of the store, and information relating to products from the particular section can be provided in response to selection of the CTA. As a further example, particular virtual media content can relate to providing one or more services, and a CTA can be provided for a specific service. Information relating to the specific service can be provided in response to selection of the CTA. Or a workflow associated with the specific service can be initiated in response to selection of the CTA. For instance, a workflow associated with the specific service can allow the user to request and/or pay for the specific service. In some embodiments, the ad CTA module 252 can provide one or more CTAs that are applicable to an entire virtual media content when a user is done viewing the virtual media content. For instance, a threshold period of time may pass after a user interacts with a 360 photo, playback of a 360 video may end, or a user may exit an immersive viewer for viewing a 360 photo or a 360 video. A CTA applicable to an entire virtual media content can be provided within the virtual media content or in a user interface that provides access to the 360 photo or the 360 video. As an example, if particular virtual media content depicts the interior of a store, a CTA for the entire store can be provided when a user is done viewing the virtual media content. Many variations are possible.

In this way, the disclosed technology can provide interactive ad content within virtual media ads or other virtual media content. For example, CTAs and related content can constitute ads within virtual media ads or other virtual media content. The disclosed technology can provide an interesting and engaging experience for users viewing virtual media ads or other virtual media content. In some embodiments, CTAs for items can be provided as an overlay. In some cases, particular virtual media content can be a captured scene from the real world, and CTAs and related content provided within the virtual media content can be considered to be augmented reality (AR) content. All examples herein are provided for illustrative purposes, and there can be many variations and other possibilities.

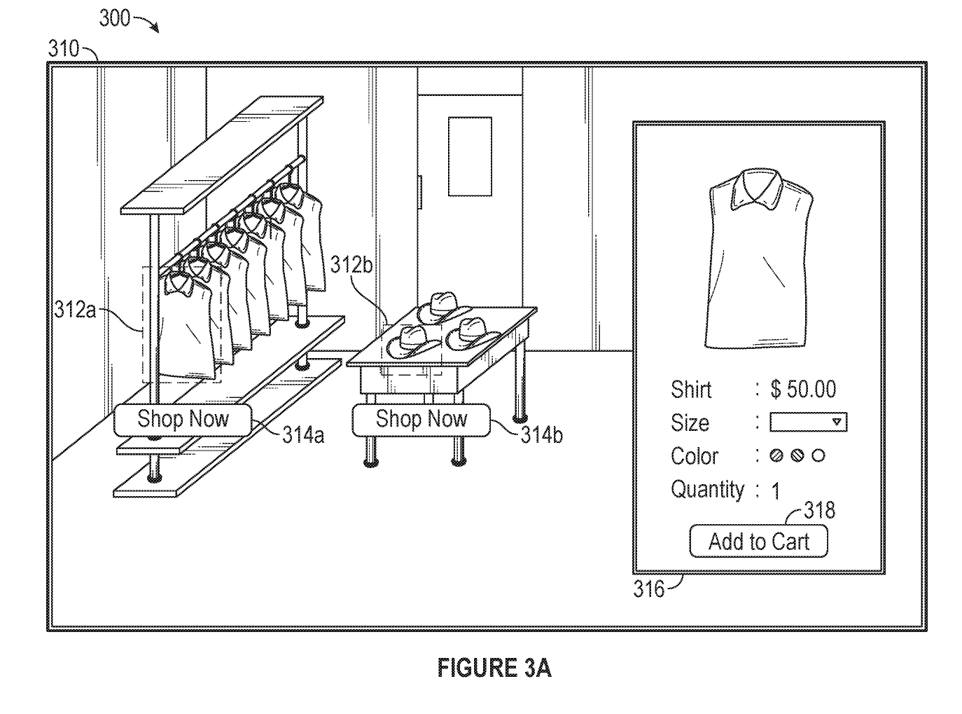

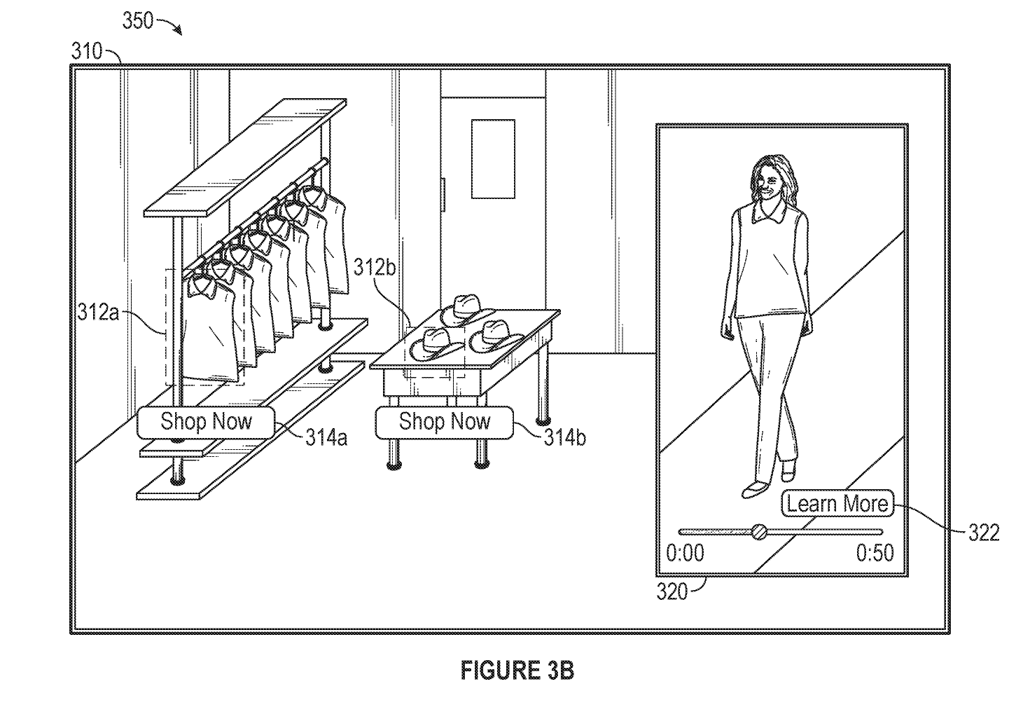

FIG. 3A illustrates an example user interface 300 for providing virtual media ads, according to an embodiment of the present disclosure. The user interface 300 shows a portion of virtual media content 310, such as a 360 photo, as shown in a viewport presented to a user experiencing a virtual reality environment. For example, the user interface 300 can be generated by or in connection with the virtual media ad module 202, as discussed herein. In the example of FIG. 3A, the virtual media content 310 depicts an interior of a store, and the store includes shirts and hats on display. A shirt in the store can be identified as an item 312a for which to display a CTA, and a hat in the store can be identified as an item 312b for which to display a CTA. The items 312a and 312b are shown in dashed lines for illustrative purposes, and the dashed lines may not be displayed to the user. A CTA 314a and a CTA 314b can be provided for the item 312a and the item 314a, respectively. In the example of FIG. 3A, the CTA 314a and the CTA 314b are shown as “Shop Now,” but other CTAs for an item can be selected based on various considerations, such as the item, the user, or both, as discussed above. If a user selects the CTA 314a or the CTA 314b, related content 316 for a corresponding item can be provided within the virtual media content 310. In the example of FIG. 3A, the related content 316 is provided in a separate window within the virtual media content 310. In the example of FIG. 3A, the CTA 314a is selected, and the related content 316 provides details associated with the shirt. The related content 316 can also include a CTA 318, which can initiate a transaction associated with the shirt. All examples herein are provided for illustrative purposes, and there can be many variations and other possibilities.

FIG. 3B illustrates an example user interface 350 for providing virtual media ads, according to an embodiment of the present disclosure. In the example shown, FIG. 3B is similar to FIG. 3A, except as to related content 320 in response to selection of the CTA 314a associated with the item 312a. In the example of FIG. 3B, the CTA 314a is selected, and the related content 320 provides media content (e.g., a video) depicting the shirt. For example, the media content can show a model wearing the shirt. The related content 320 can include a CTA 322, which can provide additional information associated with the shirt. All examples herein are provided for illustrative purposes, and there can be many variations and other possibilities.

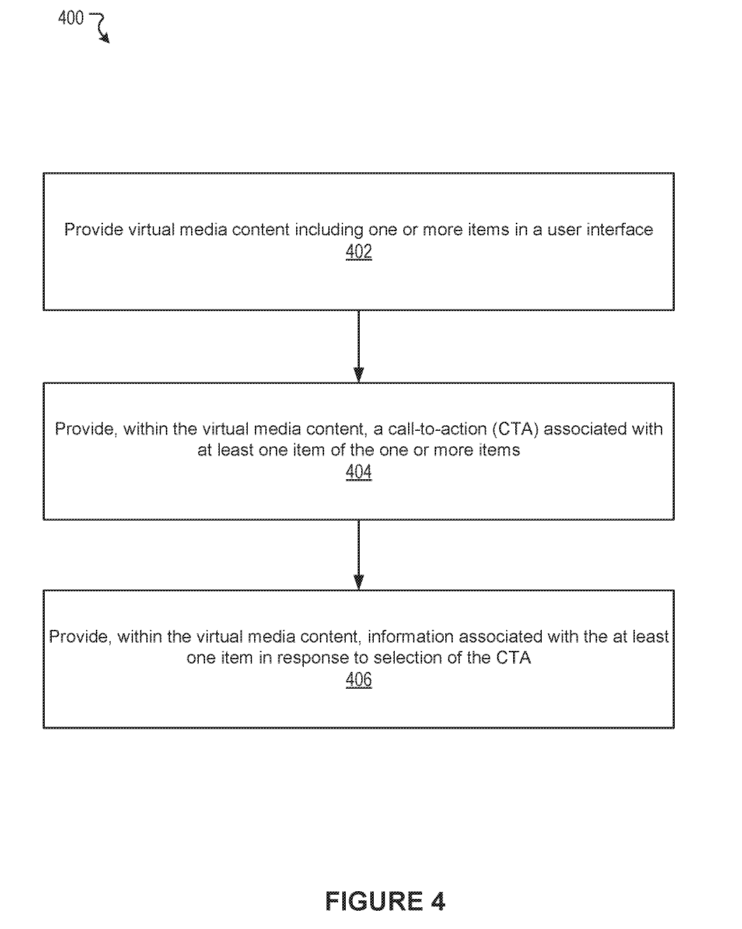

FIG. 4 illustrates an example first method 400 for providing virtual media ads, according to an embodiment of the present disclosure. It should be understood that there can be additional, fewer, or alternative steps performed in similar or alternative orders, or in parallel, based on the various features and embodiments discussed herein unless otherwise stated.

At block 402, the example method 400 can provide virtual media content including one or more items in a user interface. At block 404, the example method 400 can provide, within the virtual media content, a call-to-action (CTA) associated with at least one item of the one or more items. At block 406, the example method 400 can provide, within the virtual media content, information associated with the at least one item in response to selection of the CTA. Other suitable techniques that incorporate various features and embodiments of the present disclosure are possible.

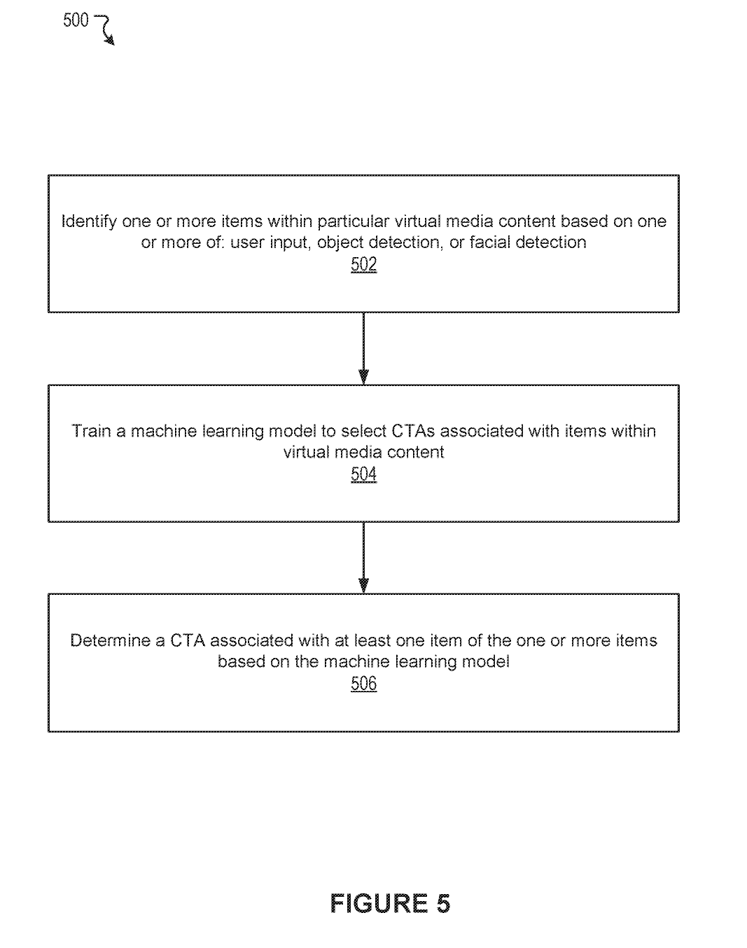

FIG. 5 illustrates an example second method 500 for providing virtual media ads, according to an embodiment of the present disclosure. It should be understood that there can be additional, fewer, or alternative steps performed in similar or alternative orders, or in parallel, based on the various features and embodiments discussed herein unless otherwise stated. Certain steps of the method 500 may be performed in combination with the example method 400 explained above.

At block 502, the example method 500 can identify one or more items within particular virtual media content based on one or more of: user input, object detection, or facial detection. At block 504, the example method 500 can train a machine learning model to select CTAs associated with items within virtual media content. At block 506, the example method 500 can determine a CTA associated with at least one item of the one or more items based on the machine learning model. Other suitable techniques that incorporate various features and embodiments of the present disclosure are possible.

It is contemplated that there can be many other uses, applications, features, possibilities, and/or variations associated with various embodiments of the present disclosure. For example, users can, in some cases, choose whether or not to opt-in to utilize the disclosed technology. The disclosed technology can, for instance, also ensure that various privacy settings, preferences, and configurations are maintained and can prevent private information from being divulged. In another example, various embodiments of the present disclosure can learn, improve, and/or be refined over time.

### Social Networking System—Example Implementation

FIG. 6 illustrates a network diagram of an example system 600 that can be utilized in various scenarios, in accordance with an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a virtual media ad module 646. The virtual media ad module 646 can be implemented with the virtual media ad module 102, as discussed in more detail herein. In some embodiments, one or more functionalities of the virtual media ad module 646 can be implemented in the user device 610.

### Hardware Implementation

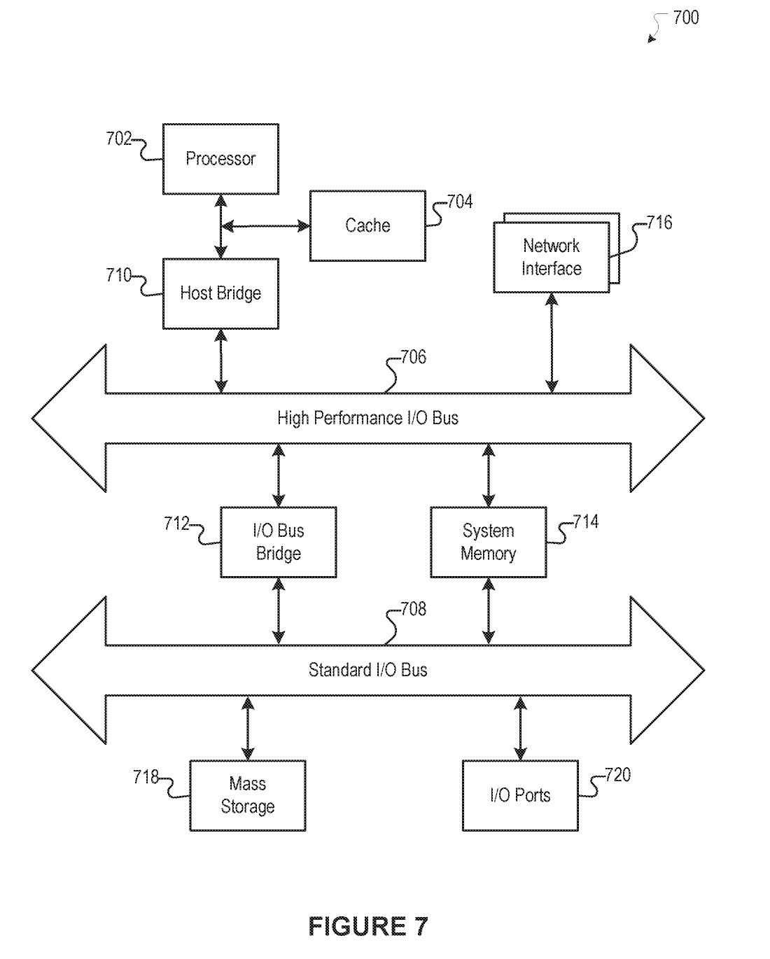

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating

System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
providing, by a computing system, virtual media content including one or more items in a user interface;
providing, by the computing system, within the virtual media content, a call-to-action (CTA) associated with at least one item of the one or more items; and
providing, by the computing system, within the virtual media content, information associated with the at least one item in response to selection of the CTA.

2. The computer-implemented method of claim 1, wherein the virtual media content includes one or more of: a 360 photo or a 360 video.

3. The computer-implemented method of claim 1, wherein the virtual media content is a virtual media advertisement.

4. The computer-implemented method of claim 1, wherein the one or more items are defined based on user input.

5. The computer-implemented method of claim 1, wherein the one or more items include one or more of an object or a face detected in the virtual media content.

6. The computer-implemented method of claim 5, wherein the object or the face is detected based on a machine learning model.

7. The computer-implemented method of claim 1, wherein the CTA associated with the at least one item is determined based on a machine learning model.

8. The computer-implemented method of claim 1, wherein the information associated with the at least one item includes one or more of: a detailed view of the at least one item, media content associated with the at least one item, or a CTA associated with initiating a transaction associated with the at least one item.

9. The computer-implemented method of claim 1, wherein the information associated with the at least one item is provided in a separate screen within the virtual media content.

10. The computer-implemented method of claim 1, wherein the CTA and the information associated with the at least one item are provided as an overlay in the virtual media content.

11. A system comprising:
at least one hardware processor; and
a memory storing instructions that, when executed by the at least one processor, cause the system to perform:
providing virtual media content including one or more items in a user interface;
providing, within the virtual media content, a call-to-action (CTA) associated with at least one item of the one or more items; and
providing, within the virtual media content, information associated with the at least one item in response to selection of the CTA.

12. The system of claim 11, wherein the one or more items are defined based on user input.

13. The system of claim 11, wherein the one or more items include one or more of an object or a face detected in the virtual media content.

14. The system of claim 13, wherein the object or the face is detected based on a machine learning model.

15. The system of claim 11, wherein the CTA associated with the at least one item is determined based on a machine learning model.

16. A non-transitory computer readable medium including instructions that, when executed by at least one hardware processor of a computing system, cause the computing system to perform a method comprising:
providing virtual media content including one or more items in a user interface;
providing, within the virtual media content, a call-to-action (CTA) associated with at least one item of the one or more items; and
providing, within the virtual media content, information associated with the at least one item in response to selection of the CTA.

17. The non-transitory computer readable medium of claim 16, wherein the one or more items are defined based on user input.

18. The non-transitory computer readable medium of claim 16, wherein the one or more items include one or more of an object or a face detected in the virtual media content.

19. The non-transitory computer readable medium of claim 18, wherein the object or the face is detected based on a machine learning model.

20. The non-transitory computer readable medium of claim 16, wherein the CTA associated with the at least one item is determined based on a machine learning model.
